(19) United States
(12) Patent Application Publication
(10) Pub. No.: US 2005/0062584 A1
(43) Pub. Date: Mar. 24, 2005

(54) High-linearity switched-resistor network for programmability

(75) Inventor: Hongwei Wang, Fremont, CA (US)

Correspondence Address: STERNE, KESSLER, GOLDSTEIN & FOX P.L.L.C., 1100 NEW YORK AVE., N.W., WASHINGTON, DC, 20005, US

(73) Assignee: Broadcom Corporation

(21) Appl. No.: 10/668,286

(22) Filed: Sep. 24, 2003

(51) Int. Cl. H01C 10/50

(52) U.S. Cl. 338/200

(57) ABSTRACT

A system (e.g., a programmable resistive device) including switches and resistors. Respective ones of each of the switches is connected in series with respective ones of each of the resistors to form switch-resistor branches. The switch-resistor branches are connected in parallel between first and second nodes. Respective ones of the switches receive control signals to turn them ON, which forms an equivalent resistor having an equivalent resistance. A resistance of the switch is substantially insignificant compared to a resistance of the resistor in each of the switch-resistor branches making the equivalent resistance substantially linear.

### BACKGROUND OF THE INVENTION

1. Field of the Invention

The present invention is related to programmable switched-resistor networks.

2. Background Art

Many chips have devices that require a different resistance during different operations of the chip. For example, programmable gain amplifiers require different resistance in feedback paths from their output to their inverting and non-inverting input nodes during different operations.

Typically, programmable resistive devices are used to most effectively allow for variable resistance in these devices. Programmable resistive devices usually have an array of resistors coupled in series between first and second nodes. A switch is associated with each resistor. A particular switch or number of switches that are ON control how many of the resistors are in a signal flow path (e.g., a current path) for a particular operation. The total number of resistor in series forms an equivalent resistance equaling a desired resistance value for the programmable resistive device.

Problems can arise when transistors (e.g., MOSFETS) are used for the switches because they exhibit non-linear behavior. This can result in a non-linear equivalent resistance.

Therefore, what is needed is a system and method that substantially reduce non-linearity in programmable resistive devices.

### BRIEF SUMMARY OF THE INVENTION

Embodiments of the present invention provide a system (e.g., a programmable resistive device) including switches and resistors. Respective ones of each of the switches are connected in series with respective ones of each of the resistors to form switch-resistor branches. The switch-resistor branches are connected in parallel between first and second nodes. Respective ones of the switches receive control signals to turn them ON, which forms an equivalent resistor having an equivalent resistance. A resistance of the switch is substantially insignificant compared to a resistance of the resistor in each of the switch-resistor branches making the equivalent resistance substantially linear.

Other embodiments of the present invention provide a method including at least the following steps. Connecting respective switches in series with respective resistors to form switch-resistor branches. Connecting in parallel the switch-resistor branches between first and second nodes. Individually controlling turning respective ones of the switches ON to form an equivalent resistor having an equivalent resistance between the first and second nodes. Using resistance values for the resistors orders of magnitude larger than resistive values for the switches, such that an equivalent resistor formed between the first and second nodes is substantially linear.

Further embodiments, features, and advantages of the present inventions, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows symbolic schematic diagram of a programmable resistor.

FIGS. 2-3 show schematic diagrams of programmable resistors having series connected resistors.

FIGS. 4-5 show schematic diagrams of various programmable resistors having parallel connected resistors according to various embodiments of the present invention.

The present invention will now be described with reference to the accompanying drawings. In the drawings, like reference numbers may indicate identical or functionally similar elements. Additionally, the left-most digit(s) of a reference number may identify the drawing in which the reference number first appears.

### DETAILED DESCRIPTION OF THE INVENTION

Overview

While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

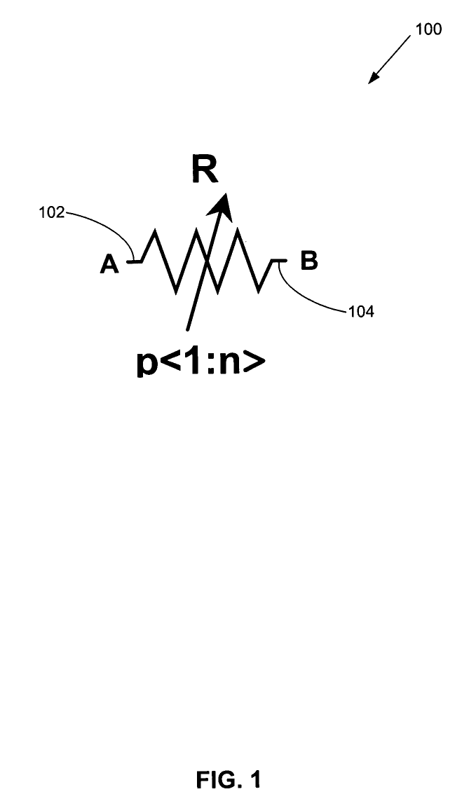

FIG. 1 shows a programmable resistor 100 coupled between a node A and a node B.

Programmable Resistive Devices with Series Connected Resistors

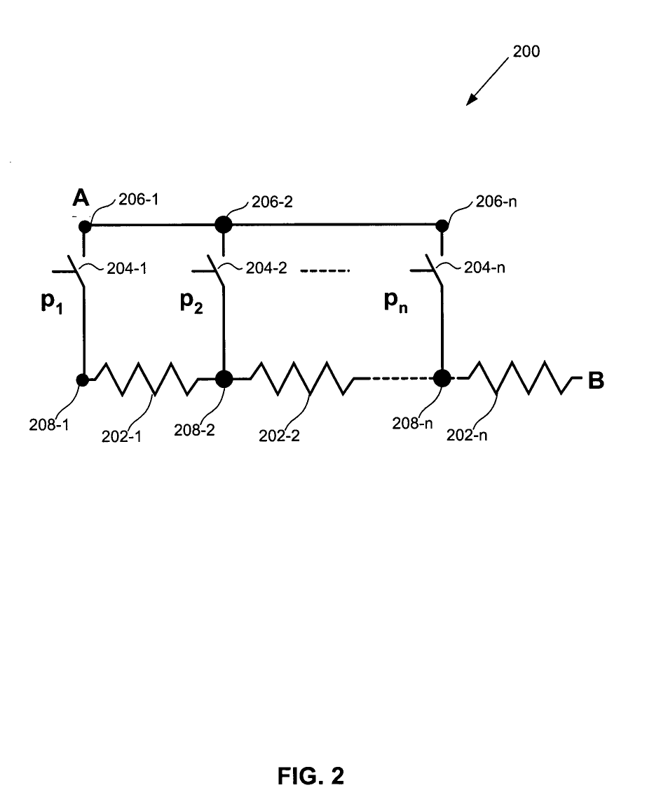

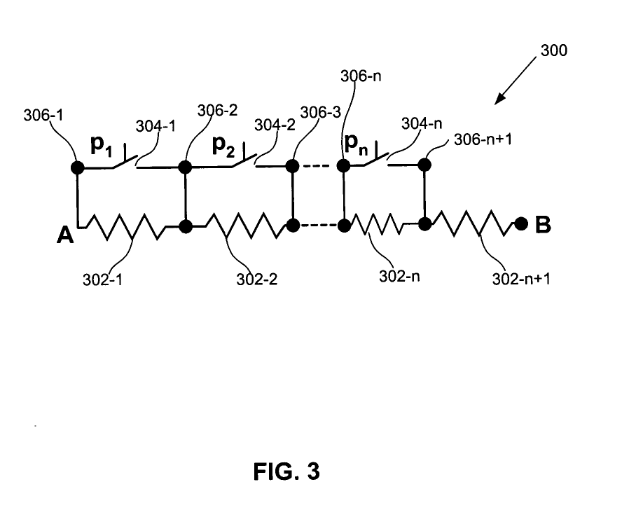

FIGS. 2-3 show two configurations for programmable resistive devices 200 and 300 having series connected resistors coupled between nodes A and B.

With reference to FIG. 2, programmable resistive device 200 includes series resistors 202-1 to 202-n (n is an integer greater than 1) and switches 204-1 to 204-n. Switches 204 are coupled between nodes 206-1 to 206-n (206-1 to 206-n and node A are a same node) and 208-1 to 208-n.

If p1 turns 204-1 ON, and all other switches are OFF, then all resistors 202 are coupled in series between node A and node B to form an equivalent resistor having an equivalent resistance. If p2 turns switch 204-20 ON, and all other switches are OFF, then only resistors 202 to the right of nodes 206-2 and 208-2 are coupled in series between node A and node B to form an equivalent resistor having an equivalent resistance. Thus, if px (x is an integer greater than 1) turns switch 204-x ON, and all other switches are OFF, all resistors 202 to the right of 206-x and 208-x are coupled in series between Node A and Node B to form an equivalent resistor having an equivalent resistance. All portions of programmable resistive device 200 to the left of nodes 206-x and 208-x are excluded, such that their resistors 202 are not included in the equivalent resistance between Node A and Node B.

With reference to FIG. 3, programmable resistive device 300 includes series resistors 302-1 to 302-n (n is an integer greater than 1) and switches 304-1 to 304-n. Switches 304 are coupled between adjacent nodes 306-1 to 306-n (306-1 and node A are a same node).

If p1 to pn turn switches 304-1 to 304-n OFF, all resistors 302 are coupled in series between node A and node B forming an equivalent resistor having an equivalent resistance. If p1 turns switch 304-1 ON, and switches p2 to pn are OFF, then a portion with resistor 302-1 is shorted, and all resistors 302 to the right of 306-2 are coupled in series between node A and node B forming an equivalent resistor having an equivalent resistance. If p1 and p2 turn switches 304-1 and 304-20N, and switches 304-3 to 304-n are OFF, then portions with resistors 302-1 and 302-2 are shorted, and only resistors 302 to the right of node 306-3 are coupled in series between node A and node B forming an equivalent resistor having an equivalent resistance. Thus, if p1 to px (x is an integer greater than 1) turn switches 304-1 to 304-x ON, and switches 304-(x+1) to 304-n are OFF, then all resistors 302 to the right of 306-(x+1) are coupled in series between Node A and Node B forming an equivalent resistor having an equivalent resistance. All portions of programmable resistive device 300 to the left of nodes 306-(x+1) are shorted, such that those resistors 302 are not included in the equivalent resistance between Node A and Node B.

Transistors or metal oxide silicon field effect transistors (MOSFETS) can be used as switches 204 or 304. MOSFETs exhibit non-linearities in regards to their resistance. When their resistances cross a threshold percentage value compared to resistors 202 and 302, the non-linearities can make the equivalent resistance between node A and node B unacceptably non-linear.

For example, programmable resistive devices 200 and 300 can have ten (10) resistors 202 or 302 of about 1 KΩ each and switches 204 or 304 exhibiting resistance of about 10 Ω. In this case, the resistance of switches 204 or 304 is around 1% of the resistance of resistors 202 or 302. Depending on an application of programmable resistive device 200 or 300, this can cross a threshold, making the equivalent resistance between nodes A and B unacceptably non-linear.

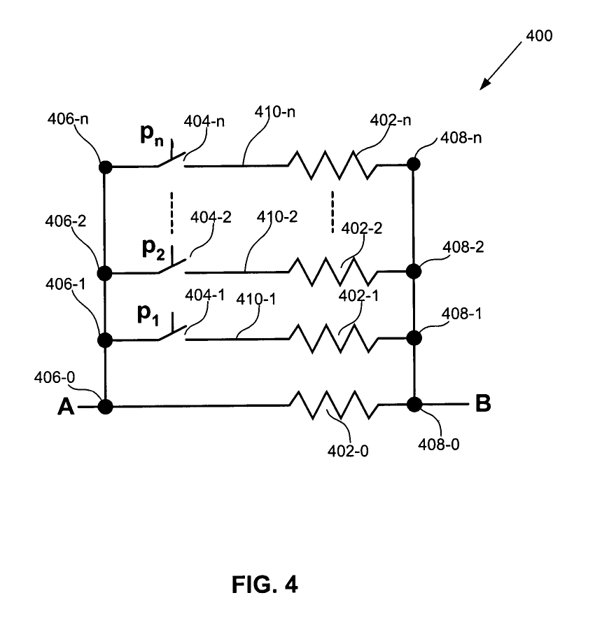

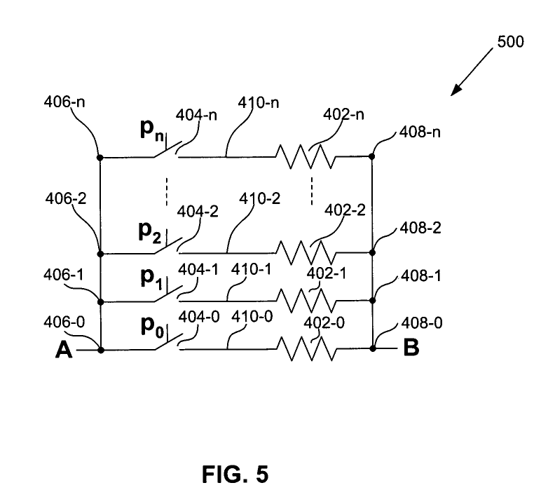

FIGS. 4 and 5 show programmable resistive devices 400 and 500 that exhibit substantially linear behavior.

Systems for Providing Substantially Linear Programmable Resistive Devices

FIG. 4 is a schematic diagram of a programmable resistive device 400 according to embodiments of the present invention. Programmable resistive device 400 includes an array of resistors 402-1 to 402-n coupled in series with an array of respective switches 404-1 to 404-n between nodes 406-0 to 406-n and 408-0 to 408-n. The series connected switches 404 and resistors 402 form switch-resistor branches 410-1 to 410-n. Switch-resistor branches 410 are coupled in parallel to each other and between nodes A and B. So, all nodes 406-0 to 406-n are the same node as node A; and all nodes 408-0 to 408-n are the same node as node B.

At all times, resistor 402-0 is coupled between nodes A and B. If p1 turns switch 404-1 ON, resistors 402-0 and 402-1 are coupled between nodes A and B, and in parallel to each other, forming an equivalent resistor with an equivalent resistance. Thus, if px turns switch 404-x ON, all resistors 402 below nodes 406-x and 408-x are coupled between nodes A and B, and in parallel to each other, forming an equivalent resistor with an equivalent resistance.

Resistors in parallel must be larger than resistors in series in order to form a same equivalent resistance. For example, parallel resistors can be orders of magnitude larger than series resistors in order to form a same equivalent resistance. However, switch 404 will have substantially a same resistance value as switch 204 or 304. Thus, with the increased resistance required of resistors 402, a percentage of a resistance of switch 404 compared to resistance of resistors 402 will be orders of magnitudes lower.

For example, if resistors 402 are about 100 KΩ and switches 404 are about 10 Ω, then the resistance of switches 404 would be 0.1% of the resistance of resistors 402. This substantially eliminates non-linearity in an equivalent resistance.

FIG. 5 is a schematic diagram of a programmable resistive device 500 according to embodiments of the present invention. Programmable resistive device 500 functions substantially the same as device 400, except device 500 allows for a situation when no current flow may exist between nodes A and B. This is because a switch 404-0 is provided in switch-resistor branch 410-0. If switch 404-0 and all other switches 404 are OFF, then no resistor 402 is coupled between nodes A and B. Also, when each switch-resistor branch 410 has different valued resistors 402, this configuration allows for any of those resistors 402 to be placed between nodes A and B by turning on their respective switches 404. Again, all nodes 406-0 to 406-n are the same node as node A; and all nodes 408-0 to 408-n are the same node as node B.

### Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1. A system comprising
switches; and
resistors,
wherein respective ones of each of the switches is connected in series with respective ones of each of the resistors to form switch-resistor branches;
wherein the switch-resistor branches are connected in parallel between first and second nodes.

2. The system of claim 1, wherein respective ones of the switches receive control signal to turn them ON, which forms an equivalent resistor having an equivalent resistance allowing respective ones of the switch-resistor branches to have current flow, such that a resistance of the switch is substantially insignificant compared to a resistance of the resistor in each of the switch-resistor branches making an equivalent resistance substantially linear.

3. The system of claim 1, wherein:
each of the switches has a first resistance value; and
each of the resistors has a second resistance value, wherein the first resistance value is orders of magnitude less than the second resistance value, such that an equivalent resistance value of each respective one of the switch-resistor branches is substantially linear.

4. The system of claim 1, wherein at least one of the switches is always closed, such that current can always flow through at least one switch-resistor branch.

5. The system of claim 1, wherein a resistor is coupled between the first and second nodes forming a resistor only branch, such that current can always flow through the resistor only branch.
